(19) United States
(12) Patent Application Publication
(10) Pub. No.: US 2005/0079630 A1
(43) Pub. Date: Apr. 14, 2005

(54) Method and apparatus for detection and quantitation of impurities in electrolytic solutions

(75) Inventors: Rem M. Lazarenko-Manevich, Obninsk (RU); Victor V. Nekrasov, Moscow (RU); Yevgeny B. Brik, Obninsk (RU); Vladimir R. Lazarenko-Manevich, Moscow (RU); Igor V. Fetisov, Moscow (RU); Oleg Lagutenko, Aventura, FL (US)

Correspondence Address: BROWDY AND NEIMARK, P.L.L.C.;624 NINTH STREET, NW, SUITE 300, WASHINGTON, DC, 20001-5303, US

(73) Assignee: Organotek Defense System Corporation, Aventura, FL (US)

(21) Appl. No.: 10/681,264

(22) Filed: Oct. 9, 2003

(51) Int. Cl. G01N 21/62

(52) U.S. Cl. 436/171

(57) ABSTRACT

Analytes are detected and/or quantified in electrolytic solutions suing Surface Enhanced Raman Scattering spectroscopy (SERS) by adsorbing the analyte on the surface of an active metal electrode placed into an electrolytic solution being analyzed and which provide periodic regeneration or modulation of surface concentration of SERS-active sites. As this occurs, the ambiguity of the measured values of the analyte signal, which is caused by instability of the surface activity of the sensor, is eliminated by optically normalizing to the total SERS signal determined by active metal adatoms.

### FIELD OF THE INVENTION

The present invention relates to analytical spectroscopy and, more particularly, to a method and apparatus for detecting and quantifying organic and inorganic compounds in electrolytic solutions using Surface-Enhanced Raman Scattering spectroscopy.

### BACKGROUND OF THE INVENTION

Analyzing trace organic contaminants in natural waters and purified waste waters requires constant improvement of existing analytical methods, as well as the development of new methods based on implementation of newly evolved concepts. Much of this requirement is linked to the development of new compounds, either synthesized by industry or produced by industrial processes as waste, which may be undesirable or even dangerous. There is also a constant increase in the rigor of demands for increasingly sensitive analytic methods for traditional environmental pollutants, brought about by the growing encroachment of modern civilization on natural plant and biological system.

Surface Enhanced Raman Spectroscopy is one of the most highly sensitive methods for analyzing extremely small traces of organic compounds in water, air and biological particles. According to the literature (Kneipp et al., 1999), this makes it possible in some cases to detect single molecules of analytes.

This great enhancement of Raman scattering make it possible to use commercial Raman scattering spectrometers for obtaining the weak Raman scattering signals of monolayer and submonolayer quantities of adsorbates on the metals. Many ways for creating the SERS-active surfaces of gold, silver, and copper have been suggested, including electrochemical roughening of the electrode surface (Marinyuk et al., 1982; Fleischman et al., 1984), vacuum sputtering of gold or silver island films (Ritchi et al., 1984) and “cold” silver films (Otto, 1984), obtaining needle-shaped silver structures using microlithography (Liao et al., 1984), creating optimum sized microspheres by sputtering silver onto spherical polymeric particles (Szabo et al, 1997), creating “spiked” silver structures in nuclear filter pores (Kudelina et al., 1991) and precipitating sol particles of silver onto an inert polymer matrix (Vo-Dinh, 1987). However, there is still the problem of obtaining low cost SERS-active surfaces which are stable both under operating conditions and in storage, and which produce reproducible data and remain constant during cleaning and activation procedures after each analysis.

The coefficient G of Raman scattering enhancement of a molecule's adsorption of light depends on many parameters: the nature of the metal and the adsorbate, the mode of processing the metal surface, the wavelength of the excitation light, and the electrode potential. Not all of these parameters can be reliably controlled.

The following two main mechanisms of SERS have been studied (Marinyuk et al., 1982; Otto, 1984):
1. The “electromagnetic mechanism”, involving increasing the intensity of the exciting and scattered electromagnetic field on a metal surface as a result of optical excitation of the localized plasmons in large-scale metal surface irregularities or in metal sol particles size from several tens up to about 200 nm; and
2. The appearance of the resonance Raman scattering (RRS) in complexes of adsorbate molecules with SERS-active point defects (metal adatoms or small clusters of metal adatoms), which are created during surface roughening by various methods, such as “chemical” mechanisms or the “adatom hypothesis”).

The quantitative contribution of each of these physical effects to the total enhancement of Raman scattering varies from one experiment to another as well as in the course of time, or when some experimental parameters are altered during the analysis. This makes it very difficult to accomplish quantitative analytical procedures by the SERS method.

It is necessary to clean and activate the electrode surface because of the possibility of the influence of adsorption at the electrode of organic compounds being analyzed along with solution impurities, adatom concentration, and other characteristics of the roughened surface, even when only traces of organic compounds or other impurities are present. Additionally, because of a gradual accumulation on the electrode of the analytes, impurities, etc. and their possible interaction with the surface and each other, the electrode must be cleaned and activated. A satisfactory solution to this has not yet been discovered.

Thus, to determine the concentration of the compounds being analyzed, the use of previously obtained calibration graphics is not sufficient. That is why SERS spectroscopy, while being an effective research method for studying surface processes, with its high sensitivity, selectivity inherent to all vibrational spectroscopy methods, applicability to analyzing both liquids and gases, sufficiently quick response to be useful, and the relative simplicity of use and interpretation of results, has not yet acquired wide application in the analysis.

### SUMMARY OF THE INVENTION

It is an object of the present invention to overcome the aforesaid deficiencies in the prior art.

It is another object of the present invention to provide higher reliability and reproducibility of analysis results by SERS spectroscopy.

It is a further object of the present invention to use special regeneration producers using the electromodulation of sensor electrode parameters during the analytical procedure.

It is still another object of the present invention to ensure durable and reproducible operation of the sensors in perfect combination with the phase-sensitive detection of the modulated SERS spectra of compounds being analyzed.

It is yet another object of the invention to provide effective optical methods of obtaining reference signals for normalizing the SERS signals of the compounds analyzed.

The present invention provides higher reliability and reproducibility of results obtained by the SERS spectroscopy method and its wider sensitivity limit range. The present invention provides special regeneration procedures using the electromodulation of sensor electrode parameters during the analytical procedure, and ensures durable and reproducible operation of the sensors in perfect combination with the phase-sensitive detection of the modulated SERS spectra of the compounds being analyzed, as well as effective optical method of obtaining reference signals for normalizing the SERS signals of the compounds analyzed.

Practically all currently known methods for obtaining SERS-active surfaces to be used for SERS spectroscopic analysis focus on creating the conditions for implementing maximum electromagnetic enhancement. The use of chemical enhancement is characteristic of some research into the SERS mechanism in electrochemical conditions and at low temperature in a vacuum (Marinyuk et al., 1982; Otto, 1984). Meanwhile, electrochemical methods allow rather selective control for the changes in the surface concentration of silver adatoms on silver electrodes by the modulation of the current of silver electrodeposition at the reversible potential in silver salt solutions (Marinyuk et al., 1980). This regime is realized at small (no more than about tens of millivolts) potential changes relative to the equilibrium potential (Bockris et al., 1964).

At near the equilibrium potential of silver, the current is consumed only for formation and dissolution of the metal adatoms, neglecting modulation of the double layer change, which is tens of times smaller, as well as the small modulation of the electroreduction and electrooxidation currents of the analyzed compound because of its low concentration. Under these conditions, the amplitude of the charge transfer oscillations determines the amplitude of the adatoms concentration oscillations. It was shown in Bockris et al., 1964 that the silver adatom concentration is (3÷160)·10⁻¹¹·mol/cm²=1.8·10¹³÷9.6·10¹⁴·cm⁻² in sufficiently concentrated silver salt solution (for example, 1 M Ag₂SO₄) The amplitude of the adatom concentration oscillations amounts of about 10% of the monolayer at current modulation frequency of 20 Hz and amplitude 1 mA/cm². In this case the potential modulation amplitude does not exceed 10 mV (Marinyuk et al., 1980). Such potential oscillations do not substantially alter either the surface concentration nor the molecular structure of the adsorbate being analyzed, the two being in principle directly dependent only on the electrode potential. These potential oscillations also do not disturb the large-scale relief of the surface. Hence, electromodulation of current in the described “galvanodynamic” regime, in contrast to the electromodulation of potential in the usual potentiodynamic regime (Van Duyne, 1979; Suëtaka et al., 1979; Ohsawa, 1980), modulates only the intensity of SERS by adsorbate molecules coupled to silver adatoms, as well as the spectral intensive background inherent to SERS spectra, which only depends on the concentration of silver adatoms and is not subjected to the influence of the adsorbed molecules (Marinyuk et al., 1981). At the same time, the intensity of this background makes it possible to obtain normalized data on the concentration of the adsorbate molecules coupled to adatoms.

The method of the present invention makes it possible to identify and detect quantitatively organic and inorganic impurities in electrolytic solutions using Surface-Enhanced Raman Scattering of light using an active metal sensor placed into a liquid to be analyzed. The active surface of the silver electrode is used as a sensor periodically, with the period T_{ed}, formed by modulating the electrodeposition current density in the galvanodynamic regime near the equilibrium potential of silver in the silver salt solution, the surface of the active electrode is illuminated with monochromatic light at frequency νₑ and the SERS spectrum is registered in a synchronous detection mode with the porosity at S<0.5 T_{ed}, the detection period of the analytical signal T_{d} having been synchronized with the modulation period of the silver electrodeposition current T_{ed}(T_{d}=T_{ed}). Using this method, the presence in the measured spectrum of the SERS structural lines at the frequencies of νₑ−Δνᵢ, which correspond to the values of the vibration frequencies in the SERS spectrum of an impurity analyzed, comprises its identification feature (signature). The contents of the impurity being identified is defined by the following expression:

$$C = \frac{{I}_{max} - {I}_{p}}{{I}_{p}}$$

Where C is the concentration sought, Iₘₐₓ is the intensity of the SERS signal measured at the peak point of the structural vibration band, Iₚ is the intensity of the SERS signal measured at the pedestal area of this band.

In another embodiment of the present invention, registration of the SERS spectrum is conducted at the scanning frequency modulation with a modulation period of T_{M}<<T_{ed}, and a modulation amplitude of Δν<Δ, where delta is the average lines' width of the measured SERS spectrum and the identification feature (signature) of an impurity being identified is the first derivative of the SERS spectrum or its derivatives of a higher order.

In another embodiment of the present invention, registration of the SERS spectrum is carried out by optical correlation spectroscopy and the identifying feature of the analyte is the correlation score of the emission being analyzed with the hardware transmission function of the receiving optical tract imitation a reference SERS spectrum (signature) of the analyte or with a model digital image (signature) of a reference SERS spectrum of the analyte.

To determine the concentration of the analyte, an interference polarizing filter is used, the transmission spectrum of which has been correlated with the distribution of intensity (position) of one or several characteristics bands of the SERS spectrum of the analyte.

It should be mentioned that both the SERS spectrum of an adsorbate and the background are to the same extent subject to the influence of the modulation of the adatom concentration. The depth of modulation of the adsorbate and the background SERS signal can in fact constitute tens of percent, depending upon the ratio of stationary concentration of adatoms and the surface concentration of all adsorbate molecules, creating the SERS signal by the electromagnetic mechanism. At the same time, the electromagnetic enhancement of the SERS by the remainder of the impurity molecules not coupled to adatoms, including the Raman spectra generated by impurity molecules in the solution, is not absolutely modulated.

The present invention provides a SERS spectroscopy method in which measurement of the SERS spectra obtained at periodically recessed sensor surface in the synchronous detection mode, carried out with a phase-sensitivity synchronous detector synchronized to the frequency of the electrodeposition current modulation, with the optimum selection of detection phase which ensures supervision of the area of states with maximal concentration of adatoms formed at the sensor surface. This method makes it possible to measures only the adatomic fraction of the SERS signal, and substantially excludes from consideration the remainder of the system and effects attributed to incidental defects, continuous unpredicted ageing of the surface, etc. Additionally, during such supervision condition there is a drastic reduction in the interfering influence of the parasitic luminescence of the dissolved impurities, which often substantially hampers SERS measurements and heavily distorts the picture supervised. All of this in combination stabilizes the parameters of the analytical operation and drastically reduces the systematic artifacts, thus ensuring the reliability and reproducibility of the results of analyses performed.

The SERS spectra obtained by the method of the present invention acquire a high specificity (selectivity) to the object of analysis and become a unique identification feature (signature) of a substance. Selectivity of the analysis, especially when analyzing multi-component compounds, is further increased in the direct measurement of the SERS derivatives.

SERS spectra in principle contain a normalizing signal for determining impurities quantitatively. This normalizing signal can be obtained using the presence of a so-called wide-band “background” signal that practically always accompanies the adsorbate structural SERS spectral bands, and which in fact constitutes its wide-band pedestal. The existence of this background is determined by the sensor superficial features, which define its adsorption activity. The background intensity is proportional to the concentration of the adsorption centers (silver adatoms), which is the reason the relation of signals measured in the background area and in lines corresponding to the vibration frequencies of an adsorbed impurity defines the concentration of the adsorbed impurity. In normal conditions, however, this signal is multifactored and of little or no use for quantitative evaluation.

The method of the present invention ensures consideration exclusively of the adatomic components of SERS-active centers. This is the reason that quantitative evaluations are simplified and become more reliable.

### BRIEF DESCRIPTION OF THE DRAWINGS

FIG. 1 illustrates a SERS spectrum of a hypothetical object measured according to the present invention.

FIG. 2a shows that changing the relative direction of polarizes' axes to 90° results in an inversion of peaks of the quasiperiodic picture.

FIG. 2b illustrates a structure line with self-intensity I_{L} whose peak coincides with the axis of one of the IP filter transmission “antinodes” and which has a continuous pedestal (background having intensity I_{B}.

### DETAILED DESCRIPTION OF THE INVENTION

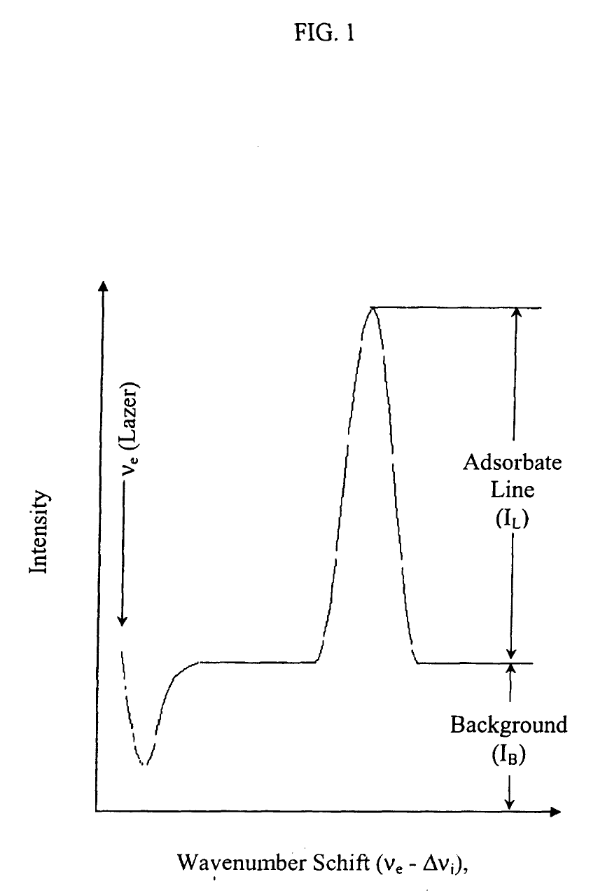

FIG. 1 illustrates a SERS spectrum of a hypothetical objected measured in the mode described above. For the sake of simplicity, the drawing illustrates only one of the vibration lines of the adsorbate spectrum. It is clear that in this case as well, the integral intensity of the adsorbate structural band is made up of a large combination of subsystems. However, in this case, the assemblage of these subsystems is uniform and is formed exclusively of adatoms with the adsorbed analyte particles. Together with this, the shape of the analyte band in this case as well constitutes a non-uniform contour, made up of a multitude of such subsystems having various interactions among themselves. That is why, for a correct determination of an adsorbate concentration at normalization to adatomic component, one should bear in mind the entire combination of adatoms as reflected by the integral band of wide-band background. In other words the exact expression for determination of the adsorbate concentration looks as follows:

$$C = \frac{{I}_{A}}{\int {I}_{B} ⅆ v}$$

Wherein I_{A} is the integral intensity of the SERS spectrum vibration band (the analyte band in FIG. 1a) and I_{B} is the intensity of the wide-band background.

Application of optical correlation spectroscopy methods, in combination with the above-mentioned technical solutions, makes possible significantly greater analytical sensitivity and selectivity of the SERS method. These methods, among others, possess the greatest spectral analysis selectivity and sensitivity, and are especially effective in detecting structured spectral signals. The principle of optical correlation spectroscopy is based upon the use of optical recording devices, the hardware transmission function of which simulates the spectral function of the analyzed emission. In particular, in the widely used mask spectroscopy, this is ensured by using a mask having both transparent and non-transparent areas positioned on the pathway of the dispersed emission being analyzed (Novikov et al., 1988). With the current state of the art electronic control devices, this effect can be achieved by special techniques of manipulating the optical selection device which provides scanning in preselected sequence of needed spectral sites by special programmed algorithms created on the basis of the measurement data on the SERS spectra of individual components.

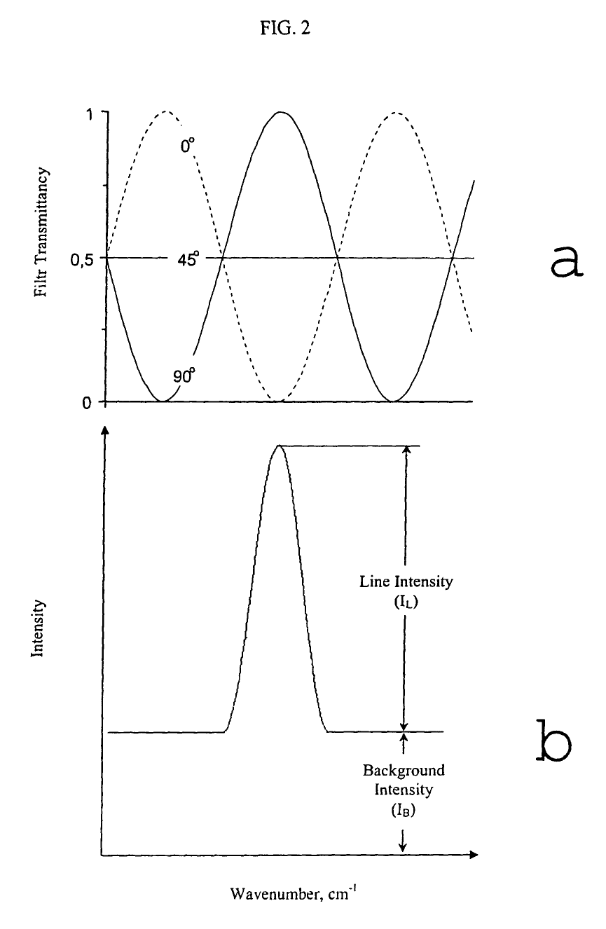

If a spectrum of the analyzed emission has a quasiregular (vibrational or vibrationally-rotational) structure, and this is the type of emissions to which SERS spectra pertain, the interference polarizing (IP) filters (Nekrasov et al., 1998) known in spectroscopy are convenient for use in the SERS hardware. The simplest of these devices, the so-called Wood's filter, consists of a retarder cut out parallel to the optical axis of a uniaxial crystal and placed between two polarizers. When the polarizers' axes are parallel or perpendicular to each other, and in such position make an angle of 45° to the crystal axis, the transmission spectrum of the IP filter constitutes a quasiperiodic set of transmission bands, determined by the interference results of polarized beams in the double-refracting crystal. When changing the relative direction of the polarizers' axes to 90°, there takes place an inversion of peaks of the quasiperiodic picture, shown in FIG. 2a.

As shown in FIG. 2a the spectral interval between the closest peaks (half-width of the IP filter transmission band) is defined by the thickness of the retarder and characteristics of the crystal material. When the direction of axes of a polarizer is aligned with the retarder axis (and in such position is respectively at 45° to the axis of a second polarizer), the quasiperiodic picture disappears and the system has a continuous transmission that reduces the transmitted light by half.

Considering the possibilities of the Wood's IP filter in an example of a detection diagram of a single line with a pedestal, imitating a typical situation for the SERS, the results are shown in FIGS. 2a and 2b. FIG. 2a shows a portion of the IP filter transmission band for three different angles of the relative direction of the first and second polarizer axes (0°, 45°, 90°). Consideration of the other respective positions is insignificant, because they only lead to a lesser amplitude of the periodical structure with respect to the half continuous transmission. FIG. 2b depicts a structural line with a self-intensity I_{L}, whose peak coincides with the axis of one of the IP filter transmission “antinodes” and which has a continuous pedestal (background) having intensity I_{B}.

As can be clearly seen from FIGS. 2a and 2b, with the relative direction of the polarizer axes at 90°, when the IP filter transmission peak coincides with that of the structural line, the registered intensity is the sum of the line and background intensities: (I⁹⁰_{reg}=I_{L}+I_{B}). Whereas with the mutually parallel axes position of both polarizers, the line intensity makes no contribution to the emission detected and only the background is registered: (I⁰_{reg}=I_{B}). Hence, having measured the SERS intensity at just these two relative polarizer axes positions, one can obtain all of the data necessary to determine an adsorbate concentration, including the normalizing parameter characterizing the adatomic component of the band. The expression to define an adsorbate concentration for this case is as follows:

$$C = \frac{{I}^{90} - {I}^{0}}{{I}^{0}}$$

Wherein the top indices of the intensity symbols mean the relative direction of the polarizer axes.

Together with this, the IP filter optical characteristics comprise another method for drastically increasing in the accuracy of measurement at the cost of minimizing the experimental errors related to the instability of an excitation source, registration system, oscillations of the average number of adsorbing centers in different regeneration cycles, etc. This possibility also lies in the constant component of the IP filter transmission and it ensures the ability to measure the complete integral intensity of the SERS spectrum. This characteristic is perfect as an extra normalizing parameter for bringing the results of all of the serial measurements to a uniform fashion.

A technical solution for an automatic device for quantitative analysis of the SERS spectra, which would put into practice all of the above-mentioned possibilities of the IP filter-based optical correlation, is achieved by arranging the modulation of a filter transmission function through a periodical alteration of axis direction of rotation of one of the polarizers. This operation may be arranged in various ways by using trivial mechanical rotation of a polarizer, or by additional insertion of a controlled optically active modulator between a polarizer and a retarder.

The algorithm for signal processing by such a periodical action device may be presented as follows:

$$C = \frac{I ( ω ) + I ( ω + \frac{π}{2} )}{2 I [ 2 \times ( ω + \frac{π}{4} ) ] \times I ( ω + \frac{π}{2} )}$$

Wherein ω is the frequency of altering the polarization direction. The zero phase shift is corresponded by the relative direction of the polarizer axes position ensuring maximum IP filter transmission in a characteristic line or in a characteristic group of lines (signature) in the SERS spectrum of an impurity (adsorbate) being analyzed.

The foregoing description of the specific embodiments will so fully reveal the general nature of the invention that others can, by applying current knowledge, readily modify and/or adapt for various application such specific embodiments without undue experimentation and without departing from the generic concept. Therefore, such adaptations and modifications should and are intended to be comprehended within the meaning and range of equivalents of the disclosed embodiments.

It is to be understood that the phraseology or terminology employed herein is for the purpose of description and not of limitation. The means and materials for carrying out various disclosed functions may take a variety of alternative forms without departing from the invention.

Thus, the expressions “means to . . . ” and “means for . . . ” as may be found in the specification above and/or in the claims below, followed by a functional statement, are intended to define and cover whatever structural, physical, chemical, or electrical element or structures which may now or in the future exist for carrying out the recited function, whether or nor precisely equivalent to the embodiment or embodiments disclosed in the specification above. It is intended that such expressions be given their broadest interpretation.

### REFERENCES

1. Kneipp K., Kneipp H., Itzkan I., Dasari R. R., Feld M. S. Chem. Rev. 1999. V.99. P.2957-2975.
2. Marinyuk V. V., Lazorenko-Manevich R. M., Kolotyrkin Ya. M. Adv. Phys. Chem. Current Developments in Electrochemistry and Corrosion.—Ed. by Ya. M. Kolotyrkin.—Moscow: MIR Publishers, 1982. P.148-191.
3. Fleishman M., Hill I. R. Gigantskoe kombinacionnoe rassejanie.—Ed. by R. Cheng and T. Furtak.—Transl. from English under ed. of V. M. Agranovich.—M.: “Mir”, 1984. P.274-290.
4. Richi G., Chen S. I. Gigantskoe kombinacionnoe rassejanie.—Ed. by R. Cheng and T. Furtak.—Transl. from English under ed. of V. M. Agranovich.—M.: “Mir”, 1984. P.354-368.
5. Otto A. Light Scattering in Solids. Vol.4.—Ed. by M. Cardona and G. Guntherodt.—Berlin: Springer, 1984. P.289-418.
6. Ljao R. F. Gigantskoe kombinacionnoe rassejanie.—Ed. by R. Cheng and T. Furtak.—Transl. from English under ed. of V. M. Agranovich.—M.: “Mir”, 1984. P.369-378.
7. Kudelina I. A., Kuznecov V. I., Mchedlishvili B. V., Nabiev I. R., Olejnikov V. A., Sokolov K. V., Shestakov V. D. Patent USSR SU No 1673929 A1. 1991. Bjul. No 32.
8. Szabo N. J., Winefordner J. D. Anal. Chem. 1997. V.69. P.2418-2425.
9. Vo-Dinh T. U.S. Pat. No. 4,674,878. 1987.
10. Marinjuk V. V., Lazorenko-Manevich R. M., Kolotyrkin JA. M. Dokl. AN SSSR. 1980. V.253. P.155-159.
11. Bokris J., Damianovich A. Sovremennye aspekty elektrohimii.—Ed. by. J. Bokris and B. Conway.—Transl. from English under ed. of Y. M. Kolotyrkina.—M.: “Mir”, 1967. P.259-391.
12. Ohsawa M., Suëtaka W. Proc. VIIth International Conf. Raman Spectrosc.—Ed. by W. F. Murphy. Amsterdam: North-Holland, 1980. P.430-431.
13. Marinjuk V. V., Lazorenko-Manevich R. M., Kolotyrkin JA. M. Electrochemistry. 1981. V.17. P.643-648.
14. Novikov V. A., Molchanov A. A. Journal of Applied Spectroscopy. 1988. V. 48, No 6. P. 1026-1030.
15. Nekrasov V. V., Surin N. M. Russian Chemical Journal. 1998. V.42, No 2. P.143-148.
16. Zaidel A. N., Ostrovskaia G. V., Ostrovsky U. A. Tehnika I praktika spektroskopii. Moscow.: “Nauka”, 1976. page. 246-251.

1. In a method for detecting and quantifying an analyte in a solution using Surface Enhanced Raman Scattering of light using an active metal sensor placed into a sample being analyzed, the improvement comprising using the active metal sensor periodically, with a period, T_{ed}, which period is formed by modulating the electrodeposition current density in a galvanodynamic regime of the electrodeposition at the equilibrium potential of the active metal in an active metal solution.

2. The method according to claim 1 wherein the surface of the active metal sensor is illuminated with monochromatic light at frequency νₑ and the SERS spectrum obtained for the analyte is registered in a synchronous detection mode with porosity at S<0.5 T_{ed}, and wherein the detection period of the analytical signal T_{d} is synchronized with the modulation period of the active metal electrodeposition current.

3. The method according to claim 2 wherein the amount of analyte is defined as:
$$C = \frac{{I}_{max} - {I}_{p}}{{I}_{p}}$$
wherein C is the concentration of the analyte; Iₘₐₓ is the intensity of the SERS signal measured at the peak point of the structural vibration band; and Iₚ is the intensity of the SERS signal measured at the pedestal area of the structural vibration band.

4. The method according to claim 1 wherein the registration of the SERS spectrum is conducted at a scanning frequency modulation with a modulation period of T_{M}<<T_{ed} and a modulation amplitude of Δν<Δ, wherein Δ is the average width of lines of the measured SERS spectrum, and the signature of the analyte is the first derivative of the SERS spectrum.

5. The method according to claim 1 wherein registration of the SERS spectrum is conducted by optical correlation spectroscopy, and the signature of the analyte is the correlation score of the emission analyzed with the hardware transmission function of a receiver imitating a reference SERS signature of the analyte or with a model digital image of a references SERS spectrum of the analyte.

6. The method according to claim 1 wherein an interference polarizing filter is used to identify the analyte, wherein the transmission spectrum of the interference polarizing filter has been correlated with the distribution of intensity of at least one characteristic band of the SERS spectrum of the analyte.
